(19) United States
(12) Patent Application Publication
(10) Pub. No.: US 2024/0025406 A1
(43) Pub. Date: Jan. 25, 2024

(54) METHOD FOR ADJUSTING SPEED OF INSTANT VEHICLE AND DEVICE FOR ADJUSTING SPEED OF INSTANT VEHICLE

(71) Applicant: Mobile Drive Netherlands B.V., Amsterdam (NL)

(72) Inventor: CHENG-KUO YANG, New Taipei (TW)

(21) Appl. No.: 18/225,710

(22) Filed: Jul. 25, 2023

(30) Foreign Application Priority Data
Jul. 25, 2022 (CN) 202210880539.5

(51) Int. Cl. B60W 30/16; B60W 40/04

(52) U.S. Cl. CPC B60W 30/16; B60W 40/04; B60W 2554/80; B60W 2720/10

(57) ABSTRACT

A method for adjusting speed of instant vehicle is provided. The method obtains a preset speed of the instant vehicle and a real position of the instant vehicle. The method determines a corresponding detection distance according to the preset speed of the instant vehicle. The method obtains a road congestion status within a range of the corresponding detection distance according to the real position of the instant vehicle. The method adjusts the preset speed of the instant vehicle according to the road congestion status within the range of the corresponding detection distance. A related electronic device and a non-transitory storage medium are provided.

### FIELD

The subject matter herein generally relates to an automatic driving technology, and particularly to a method for adjusting speed of instant vehicle and a device for adjusting speed of instant vehicle.

### BACKGROUND

Nowadays, a number of vehicle brands of the vehicles have been imported an adaptive cruise control (ACC) system. A driver can set a speed of instant vehicle and a vehicle-following distance. The ACC system can control the instant vehicle according to a preset target speed of the instant vehicle, and determine a distance between the instant vehicle and a preceding vehicle and a speed of the preceding vehicle. For example, if the preceding vehicle decelerates, the instant vehicle can follow to decelerate. If the preceding vehicle accelerates away, the instant vehicle can return to the preset target speed of the instant vehicle. However, when the target speed of the instant vehicle in the ACC system of the instant vehicle is set to be higher, the ACC system mainly pays attention to the speed of the preceding vehicle, if a large-scale congestion is occurred within a certain distance in front of the instant vehicle, the instant vehicle can not quickly brake from a higher speed via the ACC system. Moreover, the quickly braking may bring a bad experience to the driver or one or more passengers. However, if the speed of the instant vehicle is adjusted manually, the instant vehicle may directly quit the ACC system.

### SUMMARY

An embodiment of the present application provides a method for adjusting speed of instant vehicle, an electronic device, and a non-transitory storage medium.

In a first aspect, an embodiment of the present application provides a method for adjusting speed of instant vehicle. The method obtains a preset speed of the instant vehicle and a real position of the instant vehicle. The method determines a corresponding detection distance according to the preset speed of the instant vehicle. The method obtains a road congestion status within a range of the corresponding detection distance according to the real position of the instant vehicle. The method further adjusts the preset speed of the instant vehicle according to the road congestion status within the range of the corresponding detection distance.

According to some embodiments of the present application, the method obtains the road congestion status within the range of the corresponding detection distance in real time according to the real position of the instant vehicle via a navigation system.

According to some embodiments of the present application, the method obtains the road congestion status within the range of the corresponding detection distance in real time according to the real position of the instant vehicle via one or more sensors of the instant vehicle.

According to some embodiments of the present application, a detection distance comprises a first distance and a second distance. Where the second distance is greater than the first distance. The method obtains a first speed threshold and a second speed threshold. Where the second speed threshold is greater than the first speed threshold. The method determines that the corresponding detection distance is the second distance if the preset speed of the instant vehicle is greater than the second speed threshold. The method further determines that the corresponding detection distance is the first distance if the preset speed of the instant vehicle is greater than or equal to the first speed threshold and less than or equal to the second speed threshold.

According to some embodiments of the present application, the detection distance is a total of a braking distance and a buffer distance, the braking distance is different according to a difference of values of the first speed threshold or the second speed threshold, and the buffer distance is different according to a difference of the values of the first speed threshold or the second speed threshold.

According to some embodiments of the present application, the method obtains a vehicle-following distance, and obtains an inter-vehicle distance between the instant vehicle and a preceding vehicle in real time. The method obtains a current speed of the instant vehicle. The method further adjusts the current speed of the instant vehicle according to a change of the inter-vehicle distance between the instant vehicle and the preceding vehicle, causing the inter-vehicle distance between the instant vehicle and the preceding vehicle to be always consistent with the vehicle-following distance.

According to some embodiments of the present application, the method maintains the preset speed of the instant vehicle if the road congestion status within a range of the second distance is smooth. The method adjusts the preset speed of the instant vehicle to a first speed threshold if the road congestion status within the range of the second distance is crowded. The method adjusts the preset speed of the instant vehicle to a second speed threshold if the road congestion status within the range of the second distance is medium. The method maintains the preset speed of the instant vehicle if the road congestion status within a range of the first distance is smooth. The method maintains the preset speed of the instant vehicle if the road congestion status within the range of the first distance is medium. The method further adjusts the preset speed of the instant vehicle to the first speed threshold if the road congestion status within the range of the first distance is crowded.

In a second aspect, an embodiment of the present application provides an electronic device. The electronic device includes a storage device and at least one processor. The storage device storing one or more programs, which when executed by the at least one processor, cause the at least one processor to: obtain a preset speed of instant vehicle and a real position of the instant vehicle, determine a corresponding detection distance according to the preset speed of the instant vehicle, obtain a road congestion status within a range of the corresponding detection distance according to the real position of the instant vehicle, and adjust the preset speed of the instant vehicle according to the road congestion status within the range of the corresponding detection distance.

In a third aspect, an embodiment of the present application also provides a non-transitory storage medium. The non-transitory storage medium storing a set of commands, when the commands being executed by at least one processor of a vehicle, causing the at least one processor to: obtain a preset speed of instant vehicle and a real position of the instant vehicle, determine a corresponding detection distance according to the preset speed of the instant vehicle, obtain a road congestion status within a range of the corresponding detection distance according to the real position of the instant vehicle, and adjust the preset speed of the instant vehicle according to the road congestion status within the range of the corresponding detection distance.

Comparing to a nowadays technology, the disclosure has the following beneficial effects:

The disclosure can determine the road congestion statues within ranges of different detection distances according to the value of the preset speed of the instant vehicle, and determine whether to maintain or adjust the preset speed of the instant vehicle according to the road congestion statues. Thus, the disclosure can ensure that the speed of the instant vehicle always maintains within a safety range (less than or equal to the preset speed of the instant vehicle). Thus, if a vehicle emergency event is occurred in the traveling direction of the instant vehicle, the instant vehicle can quickly brake from the higher speeds, thus a sudden braking of the vehicle can be avoided, and the bad experience to the driver or one or more passengers can be avoided.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a flowchart of an embodiment of a method for adjusting speed of instant vehicle.

FIG. 2 is a flowchart of an embodiment of a process of determining a corresponding detection distance according to a preset speed of an instant vehicle.

FIG. 3 is another flowchart of an embodiment of a method for adjusting speed of instant vehicle.

FIG. 4 is a block diagram of an embodiment of a device for adjusting speed of instant vehicle.

FIG. 5 is a block diagram of an embodiment of an electronic device.

### DETAILED DESCRIPTION

For clarity, of illustration of objectives, features and advantages of the present disclosure, the drawings combined with the detailed description illustrate the embodiments of the present disclosure hereinafter. It is noted that embodiments of the present disclosure and features of the embodiments can be combined, when there is no conflict.

Various details are described in the following descriptions for better understanding of the present disclosure, however, the present disclosure may also be implemented in other ways other than those described herein. The scope of the present disclosure is not to be limited by the specific embodiments disclosed below.

Unless defined otherwise, all technical and scientific terms used herein have the same meaning as commonly understood by one of ordinary skill in the art to which the present disclosure belongs. The terms used herein in the present disclosure are only for the purpose of describing specific embodiments, and are not intended to limit the present disclosure.

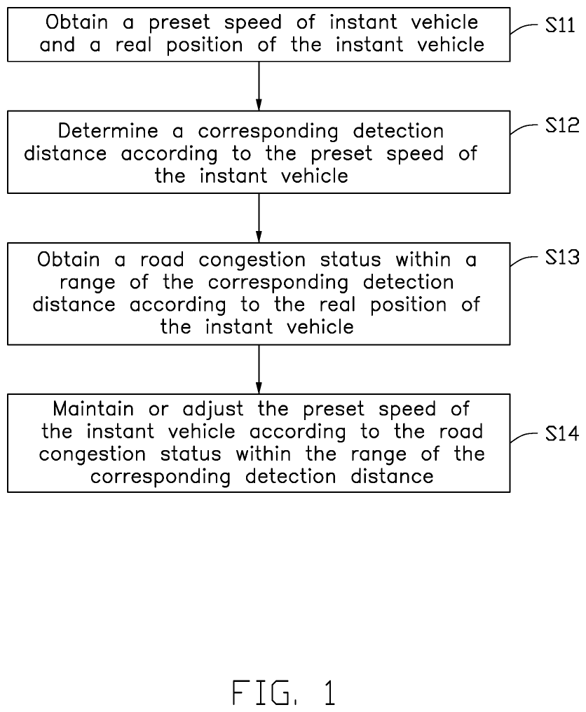

Referring to FIG. 1, a flowchart of a method for adjusting speed of instant vehicle is shown. The method is applied on an electronic device. The electronic device can be an instant vehicle, an in-vehicle infotainment device, an in-vehicle computer, or a terminal coupling to the instant vehicle, or the like. The method includes:

Step S11, obtaining a preset speed of instant vehicle and a real position of the instant vehicle.

In an exemplary embodiment, in the step S11, the preset speed of the instant vehicle can be a maximum cruising speed set by a driver in an ACC system when the ACC system of the instant vehicle is started.

Step S12, determining a corresponding detection distance according to the preset speed of the instant vehicle.

It can be understood that, a detection distance can be set in advance, and the detection distance may include one or more distances. In the embodiment, the detection distance including two distances, for example a first distance and a second distance, and the second distance being greater than the first distance can be taken as an example to illustrate the disclosure. The corresponding detection distance can be the first distance or the second distance.

Step S13, obtaining a road congestion status within a range of the corresponding detection distance according to the real position of the instant vehicle.

It can be understood that, in the embodiment, the method can obtain the road congestion status within the range of the corresponding detection distance in real time according to the real position of the instant vehicle via a navigation system.

As a possible implementation manner, the method can directly obtain the road congestion status within the range of the corresponding detection distance according to the real position of the instant vehicle from a vehicle navigation system.

As another possible implementation manner, the electronic device is coupled to a mobile terminal, the method can indirectly obtain the road congestion status within the range of the corresponding detection distance via obtaining navigation data from the mobile terminal.

Of course, in other embodiments of the disclosure, the method can obtain the road congestion status within the range of the corresponding detection distance according to one or more on-board sensors, one or more cameras, and so on. For example, the method can obtain a travel condition of the one or more vehicles in front of the instant vehicle via one or more on-board radars and the one or more cameras, to obtain the road congestion status within the range of the corresponding detection distance. In detail, the method can obtain a first number of one or more target vehicles within the range of the corresponding detection distance via the one or more cameras, and obtain a speed of the travel of the target vehicles via the one or more on-board radars. If the first number is greater than a second number which is a preset value, and the speed of the travel of the target vehicles is less than the speed of the travel of the instant vehicle, to determine whether a road congestion is occurred within the range of the corresponding detection distance.

In the embodiment, the road congestion status can be categorized into three levels, respectively smooth, medium, and crowded. The level of the road congestion status can be categorized according to an average speed of the travel of the vehicles in front of the instant vehicle obtained from the navigation system. For example, when the speed of the travel is greater than 80 km/h, the road congestion status can be smooth; when the speed of the travel is between 40 km/h and 80 km/h, the road congestion status can be medium; when the speed of the travel is less than 40 km/h, the road congestion status can be crowded.

In the embodiment, the road congestion status can be distinguished using color. For example, when the road congestion status is smooth in a segment of the road, the segment of the road can be displayed in green. When the road congestion status is medium in a segment of the road, the segment of the road can be displayed in orange. When the road congestion status is crowded in a segment of the road, the segment of the road can be displayed in red. And a darker red region of the segment of the road represents a slower speed of the travel of the vehicle in front of the instant vehicle.

Step S14, maintaining or adjusting the preset speed of the instant vehicle according to the road congestion status within the range of the corresponding detection distance.

In the embodiment, the maintaining or adjusting the preset speed of the instant vehicle according to the road congestion status within the range of the corresponding detection distance, in detail includes:

If the road congestion status within a range of the second distance is smooth, the method maintains the preset speed of the instant vehicle.

If the road congestion status within the range of the second distance is crowded, the method adjusts the preset speed of the instant vehicle to a first speed threshold. If the road congestion status within the range of the second distance is medium, the method adjusts the preset speed of the instant vehicle to a second speed threshold.

If the road congestion status within a range of the first distance is smooth, the method maintains the preset speed of the instant vehicle.

If the road congestion status within the range of the first distance is medium, the method maintains the preset speed of the instant vehicle.

If the road congestion status within the range of the first distance is crowded, the method adjusts the preset speed of the instant vehicle to the first speed threshold.

It can be understood that, in the embodiment, the second speed threshold is greater than the first speed threshold.

It can be understood that, in the embodiment, the first speed threshold and the second speed threshold can be categorized according to the road congestion status. For example, the first speed threshold is 40 km/h, the second speed threshold is 80 km/h. For example, in a case that the preset speed of the instant vehicle is greater than 80 km/h, and the second distance is 250 meters, if the road congestion status within the second distance (namely 250 meters) in front of the instant vehicle is smooth, the method maintains the preset speed of the instant vehicle. If the road congestion status within the second distance (namely 250 meters) in front of the instant vehicle is medium, the method adjusts the preset speed of the instant vehicle to the first speed threshold (namely 80 km/h). If the road congestion status within the second distance (namely 250 meters) in front of the instant vehicle is crowded, the method adjusts the preset speed of the instant vehicle to the second speed threshold (namely 40 km/h).

For example, in a case that the preset speed of the instant vehicle is greater than or equal to 40 km/h and less than or equal to 80 km/h, and the first distance is 150 meters, if the road congestion status within the first distance (namely 150 meters) in front of the instant vehicle is smooth or medium, the method maintains the preset speed of the instant vehicle. If the road congestion status within the first distance (namely 150 meters) in front of the instant vehicle is crowded, the method adjusts the preset speed of the instant vehicle to the first speed threshold (namely 40 km/h).

Obviously, the method can assist in determining whether to maintain or adjust the preset speed of the instant vehicle via determining the road congestion statues within ranges of different detection distances. Thus, the method can ensure that the speed of the instant vehicle always maintains within a safety range (less than or equal to the preset speed of the instant vehicle). Thus, if a vehicle emergency event is occurred in the traveling direction of the instant vehicle, the instant vehicle can quickly brake from the higher speeds, thus a sudden braking of the vehicle can be avoided, and the bad experience to the driver or one or more passengers can be avoided.

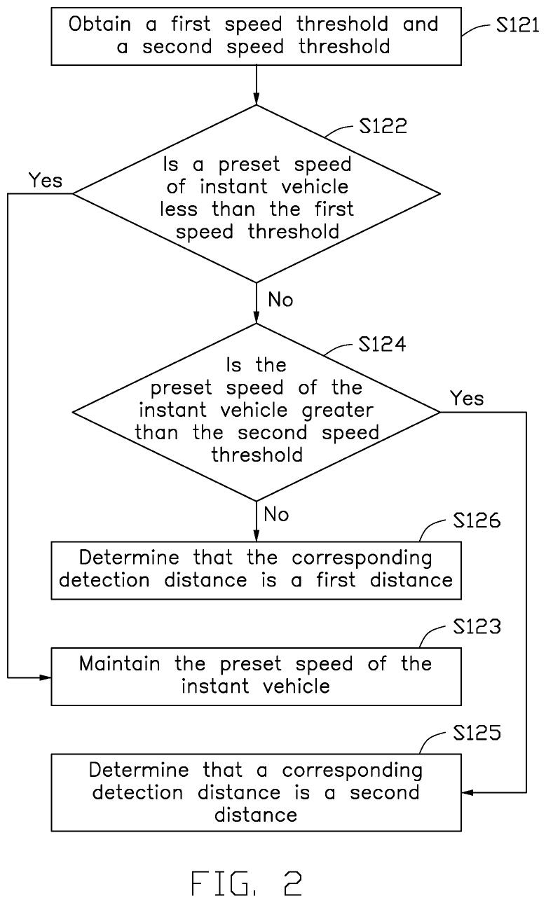

Referring also to FIG. 2, a flowchart of a processing of the step S12 is shown. In detail, in the embodiment, the determining a corresponding detection distance according to the preset speed of the instant vehicle, in detail includes:

Step S121, obtaining the first speed threshold and the second speed threshold.

Step S122, determining whether the preset speed of the instant vehicle is less than the first speed threshold.

Where, if the preset speed of the instant vehicle is less than the first speed threshold, the procedure goes to a step S123. If the preset speed of the instant vehicle is greater than or equal to the first speed threshold, the procedure goes to a step S124.

Step S123, maintaining the preset speed of the instant vehicle.

Step S124, determining whether the preset speed of the instant vehicle is greater than the second speed threshold.

Where, if the preset speed of the instant vehicle is greater than the second speed threshold, the procedure goes to a step S125. If the preset speed of the instant vehicle is less than or equal to the second speed threshold, the procedure goes to a step S126.

Step S125, determining that the corresponding detection distance is the second distance.

Step S126, determining that the corresponding detection distance is the first distance.

For example, as described above, taking the first speed threshold being 40 km/h, the second speed threshold being 80 km/h, the second distance being 250 meters, and the first distance being 150 meters as an example, if the preset speed of the instant vehicle is less than the first speed threshold (namely 40 km/h), the method maintains the preset speed of the instant vehicle. If the preset speed of the instant vehicle is greater than the second speed threshold (namely 80 km/h), the method determines that the corresponding detection distance is the second distance (namely 250 meters). If the preset speed of the instant vehicle meets a preset condition, for example, is greater than or equal to the first speed threshold (namely 40 km/h) and less than or equal to the second speed threshold (namely 80 km/h), the method determines that the corresponding detection distance is the first distance (namely 150 meters).

Namely, the detection distance includes the first distance and the second distance. The detection distance can be determined according to the first speed threshold or the second speed threshold. For example, the first distance can be determined according to the first speed threshold, and the second distance can be determined according to the second speed threshold. In detail, the detection distance L can be determined via a following formula (1):

L=L1+L2 (1)

Where, the L1 is a braking distance, and the L2 is a buffer distance. The braking distance L1 and the buffer distance L2 each can be determined according to a corresponding computation. For example, a comfort braking distance L1 can be determined according to a TuV Rehinland computation via a following formula (2):

L1=(speed÷10)×(speed÷10)+(speed÷10×3) (2)

Where, the speed is a speed threshold (for example the first speed threshold or the second speed threshold).

For example, taking determining the second distance corresponding to the second speed threshold as an example, when the speed (the second speed threshold) is 80 km/h, the method can determine that the braking distance L1 is 88 meters according to the formula (2). The buffer distance L2 can be different according to a difference of values of the second speed threshold. In the embodiment, the buffer distance L2 is 162 meters. Thus, the method can determine that the second distance L is 250 meters according to the above formula (1).

It can be understood that, in the ACC system, the greater the preset speed of the instant vehicle, the longer braking time is required when the vehicle emergency event is occurred, thus a farther detection distance is required. And, the less the preset speed of the instant vehicle, the shorter braking time is required when the vehicle emergency event is occurred, thus a closer detection distance is required. When the preset speed of the instant vehicle is small enough (for example is lower than the first speed threshold), a long-distance detection may not even be needed. Thus, the detection distance determined according to the preset speed of the instant vehicle can more accurately reflect which road segment being in a corresponding congestion state should be paid attention to by the vehicle.

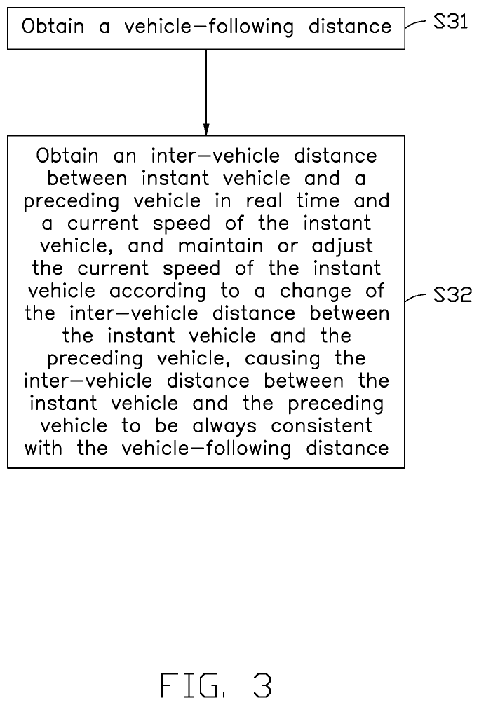

It can be understood that, referring also to FIG. 3, in other embodiments, the method further includes:

Step S31, obtaining a vehicle-following distance.

It can be understood that, when the ACC system of the instant vehicle is started, the vehicle-following distance can be set in the ACC system. Thus, the vehicle can maintain the preset speed of the instant vehicle to travel forward when no vehicle is detected within the vehicle-following distance in front of the road.

Step S32, obtaining an inter-vehicle distance between the instant vehicle and a preceding vehicle (hereinafter a front vehicle distance) in real time and a current speed of the instant vehicle, and maintaining or adjusting the current speed of the instant vehicle according to a change of the front vehicle distance, causing the front vehicle distance to be always consistent with the vehicle-following distance.

It can be understood that, the front vehicle distance can be detected by one or more sensors. The one or more sensors can be a radar, an infrared sensor, an ultrasonic sensor, or other sensors having a function for detecting the distance.

In detail, when the front vehicle distance detected by the one or more sensors is ever decreasing, or a new vehicle-following target is detected to appear within the vehicle-following distance, the method can transmit a first executing signal to an engine or a braking system to low the speed of the instant vehicle, thus a detected front vehicle distance in real time can always maintain to be consistent with the set vehicle-following distance.

When the front vehicle distance detected by the one or more sensors is ever increasing or no vehicle-following target is existed within the vehicle-following distance, the method can transmit a second executing signal to the engine or the braking system to improve the speed of the instant vehicle, thus the detected front vehicle distance in real time can always maintain to be consistent with the set vehicle-following distance, until the speed of the instant vehicle reaches the preset speed of the instant vehicle, and then stop accelerating. Thus, a safety distance of the travel can be maintained between the instant vehicle and the preceding vehicle.

It can be understood that, the method can reduce a control of the driver to the speed of the instant vehicle via the ACC system, thus a frequent cancellation and setting of the preset speed of the instant vehicle of the ACC system can be avoided.

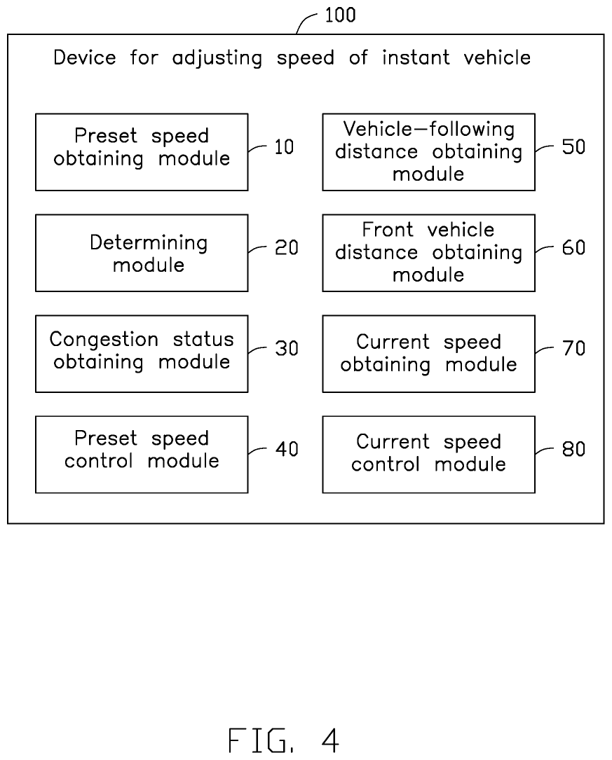

Referring to FIG. 4, a block diagram of a device for adjusting speed of instant vehicle is shown. The device 100 is configured to adjust a preset speed of the instant vehicle in the ACC system. The device 100 includes a preset speed obtaining module 10, a determining module 20, a congestion status obtaining module 30, and a preset speed control module 40.

The preset speed obtaining module 10 is configured to obtain a preset speed of instant vehicle and a real position of the instant vehicle. A detail can refer to the related description of the step S11 and the FIG. 1, which will not be described herein.

The determining module 20 is configured to determine a corresponding detection distance according to the preset speed of the instant vehicle. A detail can refer to the related description of the step S12, the FIG. 1, and the FIG. 2, which will not be described herein.

The congestion status obtaining module 30 is configured to obtain a road congestion status within a range of the corresponding detection distance according to the real position of the instant vehicle. A detail can refer to the related description of the step S13 and the FIG. 1, which will not be described herein.

The preset speed control module 40 is configured to maintain or adjust the preset speed of the instant vehicle according to the road congestion status within the range of the corresponding detection distance. A detail can refer to the related description of the step S14 and the FIG. 1, which will not be described herein.

In the embodiment, the device 100 further includes a vehicle-following distance obtaining module 50, a front vehicle distance obtaining module 60, a current speed obtaining module 70, and a current speed control module 80. The vehicle-following distance obtaining module 50 is configured to obtain a vehicle-following distance. The front vehicle distance obtaining module 60 is configured to obtain an inter-vehicle distance between the instant vehicle and a preceding vehicle (hereinafter a front vehicle distance) in real time. Where, the front vehicle distance is obtained via one or more sensors. The current speed obtaining module is configured to obtain a current speed of the instant vehicle. The current speed control module 80 is configured to maintain or adjust the current speed of the instant vehicle according to a change of the front vehicle distance, causing the front vehicle distance to be always consistent with the vehicle-following distance. A detail can refer to the related description of the step S31, the step S32, and the FIG. 3, which will not be described herein.

The device 100 can reduce a control of the driver to the speed of the instant vehicle via the ACC system, thus a frequent cancellation and setting of the preset speed of the instant vehicle of the ACC system can be avoided.

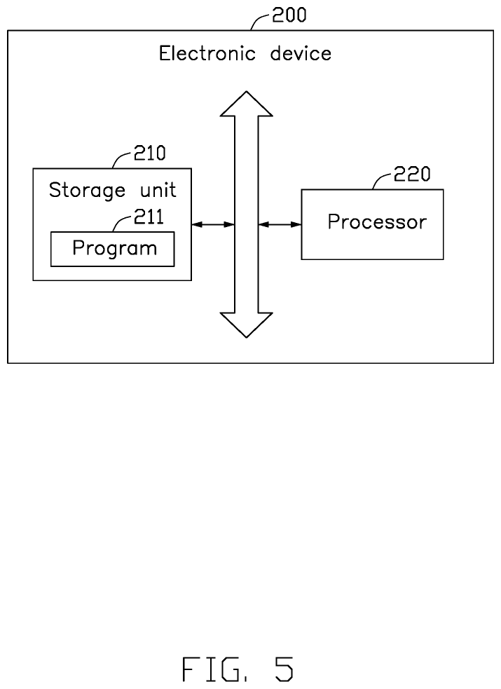

Referring to FIG. 5, a block diagram of an electronic device is shown. The electronic device 200 is configured to adjust a speed of the instant vehicle.

The electronic device 200 can include a storage unit 210, at least one processor 220, and one or more programs 211 stored in the storage unit 210 and can be run on the at least one processor 220. The at least one processor 220 can execute the one or more programs 211 to accomplish the steps of the exemplary method, for example the steps S11˜S14 in the FIG. 1, the steps S121˜S126 in the FIG. 2, and the steps S31˜S32 in the FIG. 3. Or, the at least one processor 220 can execute the one or more programs 211 to accomplish the function of modules/units of the exemplary device, for example the modules/units in the FIG. 4.

The one or more programs 211 can be divided into one or more modules/units. The one or more modules/units can be stored in the storage unit 210 and executed by the at least one processor 220 to accomplish the object of the present disclosure. The one or more modules/units can be a series of program instruction segments which can perform specific functions, and the instruction segment is configured to describe the execution process of the one or more programs 211 in the electronic device 200. For example, the one or more programs 211 can be divided into the preset speed obtaining module 10, the determining module 20, the congestion status obtaining module 30, the preset speed control module 40, the vehicle-following distance obtaining module 50, the front vehicle distance obtaining module 60, the current speed obtaining module 70, and the current speed control module 80 as shown in the FIG. 4. The detail function of the modules can refer to the exemplary device 100.

The electronic device 200 can be any suitable electronic device, for example, a vehicle, an in-vehicle infotainment device, an in-vehicle computer, or terminal coupling to the instant vehicle, or the like. A person skilled in the art knows that the electronic device is only an example, and does not be considered as limiting of the electronic device 200, the electronic device 200 may include more or fewer parts than the diagram, or combine of certain parts, or includes different parts, such as the electronic device 200 can also include one or more input and output devices, one or more network access devices, one or more buses, and so on.

The at least one processor 220 can be one or more central processing units (CPU), or it can be one or more other universal processors, digital signal processors (DSP), application specific integrated circuits (ASIC), field-programmable gate arrays (FPGA), or other programmable logic devices, discrete gate or transistor logic, discrete hardware components, and so on. The at least one processor 220 can be a microprocessor or the at least one processor 220 can be any regular processor, or the like. The at least one processor 220 can be a control center of the electronic device 200, using a variety of interfaces and lines to connect various parts of the entire electronic device 200.

The storage unit 210 stores the one or more programs and/or modules/units. The at least one processor 220 can run or execute the one or more programs and/or modules/units stored in the storage unit 210, call out the data stored in the storage unit 210, and accomplish the various functions of the electronic device 200. The storage unit 210 may include a program area and a data area. The program area can store an operating system, and applications that are required for the at least one function, such as sound playback features, images playback functions, and so on. The data area can store data created according to the use of the electronic device 200, such as video data, audio data, photobook data, and so on. In addition, the storage unit 210 can include high-speed random access memory and non-transitory storage medium, such as hard disk, memory, plug-in hard disk, smart media card, secure digital, flash card, at least one disk storage device, flash memory, or other transitory storage medium.

In the embodiments of this application, division into modules is an example, and is merely logical function division. During actual implementation, there may be another division manner. In addition, functional modules in the embodiments of this application may be integrated into one processor, or each of the modules may exist alone physically, or two or more modules may be integrated into one module. The integrated module may be implemented in a form of hardware, or may be implemented in a form of hardware and a software functional module.

The disclosure can assist in determining whether to maintain or adjust the preset speed of the instant vehicle via determining the road congestion statues within ranges of different detection distances. Thus, the disclosure can ensure that the speed of the instant vehicle always maintains within a safety range (less than or equal to the preset speed of the instant vehicle). Thus, if a vehicle emergency event is occurred in the traveling direction of the instant vehicle, the instant vehicle can quickly brake from the higher speeds, thus a sudden braking of the vehicle can be avoided, and the bad experience to the driver or one or more passengers can be avoided.

Finally, the above embodiments are only used to illustrate technical solutions of the present disclosure, and are not to be taken as restrictions on the technical solutions. Although the present disclosure has been described in detail with reference to the above embodiments, those skilled in the art should understand that the technical solutions described in one embodiments can be modified, or some of technical features can be equivalently substituted, and that these modifications or substitutions are not to detract from the essence of the technical solutions or from the scope of the technical solutions of the embodiments of the present disclosure.

What is claimed is:

1. A method for adjusting speed of instant vehicle comprising:
obtaining a preset speed of the instant vehicle and a real position of the instant vehicle;
determining a corresponding detection distance according to the preset speed of the instant vehicle;
obtaining a road congestion status within a range of the corresponding detection distance according to the real position of the instant vehicle; and
adjusting the preset speed of the instant vehicle according to the road congestion status within the range of the corresponding detection distance.

2. The method according to claim 1, wherein the obtaining the road congestion status within the range of the corresponding detection distance according to the real position of the instant vehicle comprises:
obtaining the road congestion status within the range of the corresponding detection distance in real time according to the real position of the instant vehicle via a navigation system.

3. The method according to claim 1, wherein the obtaining the road congestion status within the range of the corresponding detection distance according to the real position of the instant vehicle comprises:
obtaining the road congestion status within the range of the corresponding detection distance in real time according to the real position of the instant vehicle via one or more sensors of the instant vehicle.

4. The method according to claim 1, wherein a detection distance comprises a first distance and a second distance, where the second distance is greater than the first distance;
the determining the corresponding detection distance according to the preset speed of the instant vehicle comprises:
obtaining a first speed threshold and a second speed threshold; where the second speed threshold is greater than the first speed threshold;
determining that the corresponding detection distance is the second distance if the preset speed of the instant vehicle is greater than the second speed threshold;
determining that the corresponding detection distance is the first distance if the preset speed of the instant vehicle is greater than or equal to the first speed threshold and less than or equal to the second speed threshold.

5. The method according to claim 4, wherein:
the detection distance is a total of a braking distance and a buffer distance, the braking distance is different according to a difference of a plurality of values of the first speed threshold or the second speed threshold, and the buffer distance is different according to a difference of the values of the first speed threshold or the second speed threshold.

6. The method according to claim 1, wherein the method further comprises:
obtaining a vehicle-following distance;
obtaining an inter-vehicle distance between the instant vehicle and a preceding vehicle in real time;
obtaining a current speed of the instant vehicle;
adjusting the current speed of the instant vehicle according to a change of the inter-vehicle distance between the instant vehicle and the preceding vehicle, causing the inter-vehicle distance between the instant vehicle and the preceding vehicle to be always consistent with the vehicle-following distance.

7. The method according to claim 1, wherein the adjusting the preset speed of the instant vehicle according to the road congestion status within the range of the corresponding detection distance comprises:
maintaining the preset speed of the instant vehicle if the road congestion status within a range of the second distance is smooth;
adjusting the preset speed of the instant vehicle to a first speed threshold if the road congestion status within the range of the second distance is crowded;
adjusting the preset speed of the instant vehicle to a second speed threshold if the road congestion status within the range of the second distance is medium;
maintaining the preset speed of the instant vehicle if the road congestion status within a range of the first distance is smooth;
maintaining the preset speed of the instant vehicle if the road congestion status within the range of the first distance is medium;
adjusting the preset speed of the instant vehicle to the first speed threshold if the road congestion status within the range of the first distance is crowded.

8. An electronic device comprising:
a storage device;
at least one processor; and
the storage device storing one or more programs, which when executed by the at least one processor, cause the at least one processor to:
obtain a preset speed of instant vehicle and a real position of the instant vehicle;
determine a corresponding detection distance according to the preset speed of the instant vehicle;
obtain a road congestion status within a range of the corresponding detection distance according to the real position of the instant vehicle; and
adjust the preset speed of the instant vehicle according to the road congestion status within the range of the corresponding detection distance.

9. The electronic device according to claim 8, wherein further causes the at least one processor to:
obtain the road congestion status within the range of the corresponding detection distance in real time according to the real position of the instant vehicle via a navigation system.

10. The electronic device according to claim 8, wherein further causes the at least one processor to:
obtain the road congestion status within the range of the corresponding detection distance in real time according to the real position of the instant vehicle via one or more sensors of the instant vehicle.

11. The electronic device according to claim 8, wherein a detection distance comprises a first distance and a second distance, where the second distance is greater than the first distance;
the electronic device further causes the at least one processor to:
obtain a first speed threshold and a second speed threshold; where the second speed threshold is greater than the first speed threshold;
determine that the corresponding detection distance is the second distance if the preset speed of the instant vehicle is greater than the second speed threshold;
determine that the corresponding detection distance is the first distance if the preset speed of the instant vehicle is greater than or equal to the first speed threshold and less than or equal to the second speed threshold.

12. The electronic device according to claim 11, wherein:
the detection distance is a total of a braking distance and a buffer distance, the braking distance is different according to a difference of a plurality of values of the first speed threshold or the second speed threshold, and the buffer distance is different according to a difference of the values of the first speed threshold or the second speed threshold.

13. The electronic device according to claim 8, wherein further causes the at least one processor to:
obtain a vehicle-following distance;
obtain an inter-vehicle distance between the instant vehicle and a preceding vehicle in real time;
obtain a current speed of the instant vehicle;
adjust the current speed of the instant vehicle according to a change of the inter-vehicle distance between the instant vehicle and the preceding vehicle, causing the inter-vehicle distance between the instant vehicle and the preceding vehicle to be always consistent with the vehicle-following distance.

14. The electronic device according to claim 8, wherein further causes the at least one processor to:
maintain the preset speed of the instant vehicle if the road congestion status within a range of the second distance is smooth;
adjust the preset speed of the instant vehicle to a first speed threshold if the road congestion status within the range of the second distance is crowded;
adjust the preset speed of the instant vehicle to a second speed threshold if the road congestion status within the range of the second distance is medium;
maintain the preset speed of the instant vehicle if the road congestion status within a range of the first distance is smooth;
maintain the preset speed of the instant vehicle if the road congestion status within the range of the first distance is medium;
adjust the preset speed of the instant vehicle to the first speed threshold if the road congestion status within the range of the first distance is crowded.

15. A non-transitory storage medium storing a set of commands, when the commands being executed by at least one processor of a vehicle, causing the at least one processor to:
obtain a preset speed of instant vehicle and a real position of the instant vehicle;
determine a corresponding detection distance according to the preset speed of the instant vehicle;
obtain a road congestion status within a range of the corresponding detection distance according to the real position of the instant vehicle; and
adjust the preset speed of the instant vehicle according to the road congestion status within the range of the corresponding detection distance.

16. The non-transitory storage medium according to claim 15, wherein further causes the at least one processor to:
obtain the road congestion status within the range of the corresponding detection distance in real time according to the real position of the instant vehicle via a navigation system.

17. The non-transitory storage medium according to claim 15, wherein further causes the at least one processor to:
obtain the road congestion status within the range of the corresponding detection distance in real time according to the real position of the instant vehicle via one or more sensors of the instant vehicle.

18. The non-transitory storage medium according to claim 15, wherein a detection distance comprises a first distance and a second distance, where the second distance is greater than the first distance;
the non-transitory storage medium further causes the at least one processor to:
obtain a first speed threshold and a second speed threshold; where the second speed threshold is greater than the first speed threshold;
determine that the corresponding detection distance is the second distance if the preset speed of the instant vehicle is greater than the second speed threshold;
determine that the corresponding detection distance is the first distance if the preset speed of the instant vehicle is greater than or equal to the first speed threshold and less than or equal to the second speed threshold.

19. The non-transitory storage medium according to claim 15, wherein further causes the at least one processor to:
obtain a vehicle-following distance;
obtain an inter-vehicle distance between the instant vehicle and a preceding vehicle in real time;
obtain a current speed of the instant vehicle;
adjust the current speed of the instant vehicle according to a change of the inter-vehicle distance between the instant vehicle and the preceding vehicle, causing the inter-vehicle distance between the instant vehicle and the preceding vehicle to be always consistent with the vehicle-following distance.

20. The non-transitory storage medium according to claim 15, wherein further causes the at least one processor to:
maintain the preset speed of the instant vehicle if the road congestion status within a range of the second distance is smooth;
adjust the preset speed of the instant vehicle to a first speed threshold if the road congestion status within the range of the second distance is crowded;
adjust the preset speed of the instant vehicle to a second speed threshold if the road congestion status within the range of the second distance is medium;
maintain the preset speed of the instant vehicle if the road congestion status within a range of the first distance is smooth;
maintain the preset speed of the instant vehicle if the road congestion status within the range of the first distance is medium;
adjust the preset speed of the instant vehicle to the first speed threshold if the road congestion status within the range of the first distance is crowded.
